(19) United States
(12) Patent Application Publication
(10) Pub. No.: US 2026/0161519 A1
(43) Pub. Date: Jun. 11, 2026

(54) VARIANT AGNOSTIC MULTI-PHASE HARDWARE ENABLED BUILT-IN SELF-TEST (BIST)

(71) Applicant: QUALCOMM Incorporated, San Diego, CA (US)

(72) Inventors: Rajesh Kumar TIWARI, Bangalore (IN); K.M.Sankar NAMPOOTHIRI, Thiruvananthapuram (IN); Mohammed Zuber P MALEK, Bengaluru (IN); Rajesh BURAGAYALA, Bangalore (IN)

(21) Appl. No.: 18/970,822

(22) Filed: Dec. 5, 2024

(51) Int. Cl. G06F 11/22; G06F 11/27

(52) U.S. Cl. CPC G06F 11/2242; G06F 11/27

(57) ABSTRACT

Apparatus, methods, and computer program products for wireless communication are provided. An example method may include identifying whether each of a set of processing cores is functional or non-functional, where the set of processing cores is associated with a testing process at the device. The example method may further include selecting a subset of processing cores in the set of processing cores for the testing process based on whether each of the set of processing cores is functional or non-functional, where each of the subset of processing cores is functional. The example method may further include outputting an indication of the selection of the subset of processing cores for the testing process.

### TECHNICAL FIELD

The present disclosure relates generally to communication systems, and more particularly, to communication systems with devices with a built-in self-test (BIST).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a device are provided. The apparatus may include at least one memory and at least one processor coupled to the at least one memory. Based at least in part on information stored in the at least one memory, the at least one processor, individually or in any combination, is configured to device identify whether each of a set of processing cores is functional or non-functional, where the set of processing cores is associated with a testing process at the device. Based at least in part on information stored in the at least one memory, the at least one processor, individually or in any combination, is configured to select a subset of processing cores in the set of processing cores for the testing process based on whether each of the set of processing cores is functional or non-functional, where each of the subset of processing cores is functional. Based at least in part on information stored in the at least one memory, the at least one processor, individually or in any combination, is configured to output an indication of the selection of the subset of processing cores for the testing process.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example processing for various components.

FIG. 5 is a diagram illustrating an example of a vehicle performing road object detection.

FIG. 6 is a diagram illustrating an example of a vehicle performing a map over-the-air process.

FIG. 7 is a diagram illustrating an example of a disable or fuse-based phase remapping for control signals.

FIG. 8A is a diagram illustrating an example of a disable or fuse-based core bypass control.

FIG. 8B is a diagram illustrating another example of a disable or fuse-based core bypass control.

FIG. 9 is a diagram illustrating an example of ring gating at sub-system level.

FIG. 10 is a diagram illustrating an example of logic BIST (LBIST) logic manipulation using the bypass data.

FIG. 11 is a diagram illustrating example procedures at a processor to perform built-in self-test (BIST).

FIG. 12 is a flowchart of a method of wireless communication.

FIG. 13 is a flowchart of a method of wireless communication.

FIG. 14 is a diagram illustrating an example of a hardware implementation for an example apparatus and/or network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

System-on-chips (SOCs) may be mainly multi-processing core. The concept of fusing or completely turning off non-functional cores or underperforming cores may be a process used for ensuring SOC performance. Aspects provided herein may enable a built-in self-test (BIST) for identifying non-functional cores.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

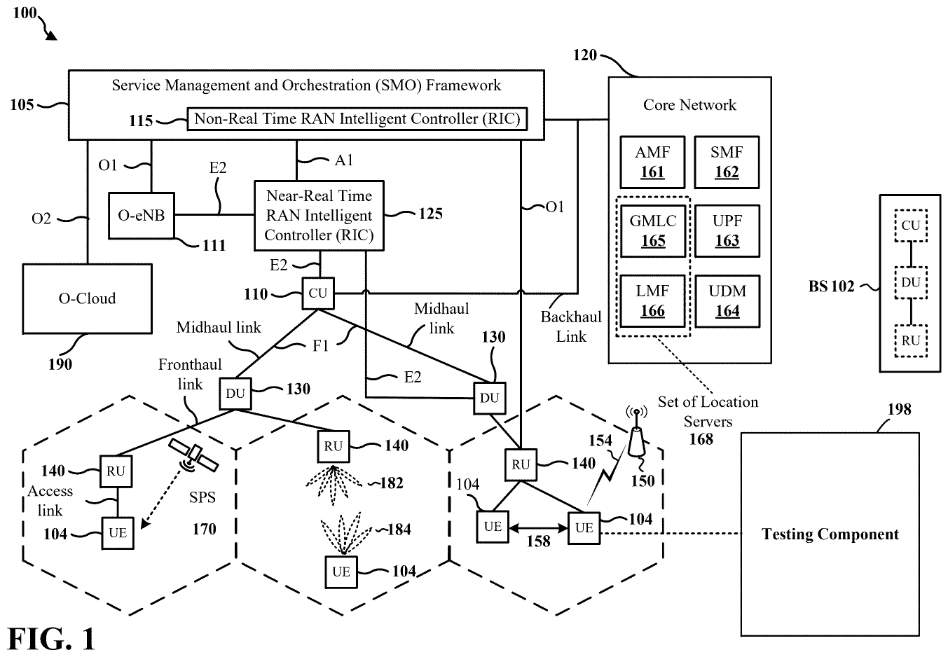

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface).

For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a testing component 198. In some aspects, the testing component 198 may be configured to identify whether each of a set of processing cores is functional or non-functional, where the set of processing cores is associated with a testing process at the device. In some aspects, the testing component 198 may be further configured to select a subset of processing cores in the set of processing cores for the testing process based on whether each of the set of processing cores is functional or non-functional, where each of the subset of processing cores is functional. In some aspects, the testing component 198 may be further configured to output an indication of the selection of the subset of processing cores for the testing process.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

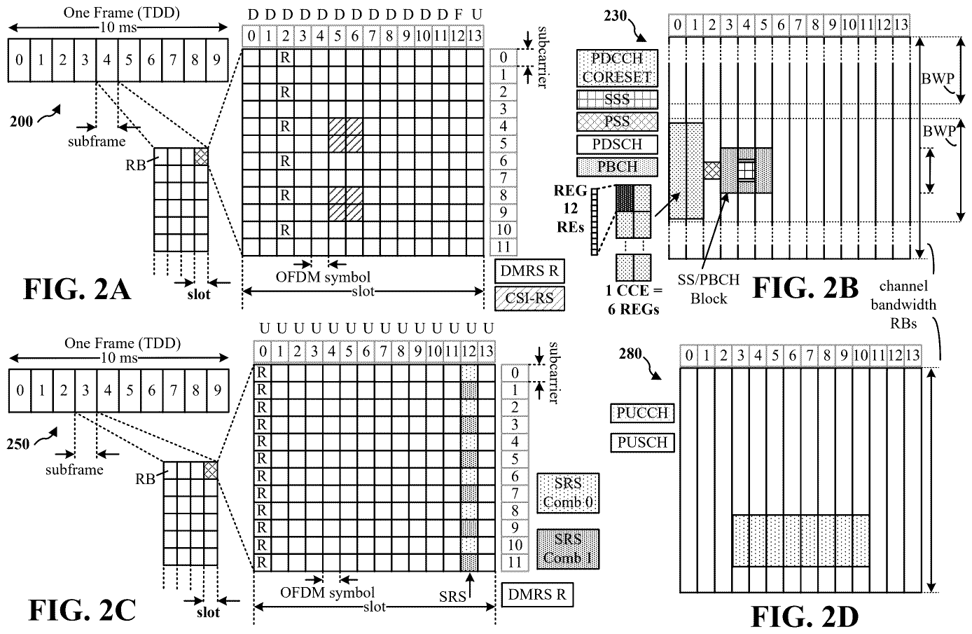

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

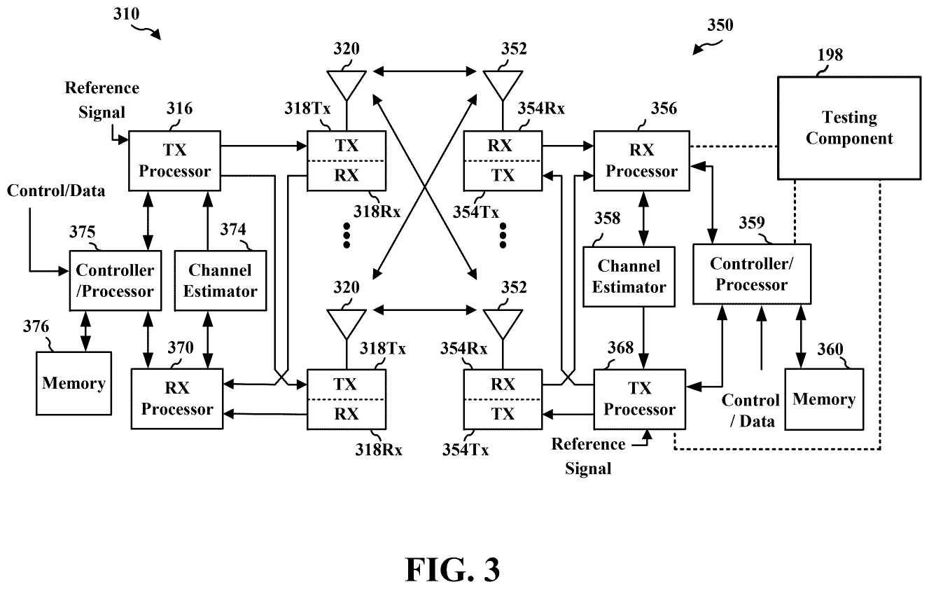

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with testing component 198 of FIG. 1.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

In some aspects, a display device may present frames at different frame rates on the first display panel and the second display panel. For instance, a display panel may present frames at 60 frames per second (FPS) on both the first display panel and the second display panel, 45 FPS on both the first display panel and the second display panel, etc. The display device may synchronize frame rates of content with refresh rates of the display panels (via a vertical synchronization process, which may be referred to as vsync, Vsync, VSync, or VSYNC). For instance, content may be available at 60 FPS and the first display panel and the second display panel may have a refresh rate of 95 Hz. Via Vsync, the refresh rate of the first display panel and the second display panel may be set to 60 Hz to match the 60 FPS content.

As indicated herein, VSync is a graphics technology that synchronizes the frame rate of an application/game with a refresh rate at a display (e.g., a display on a client device). Vsync may be utilized as a manner in which to deal with screen tearing (i.e., the screen displays portions of multiple frames at once). That can result in the display appearing to be split along a line. Tearing may occur when the display refresh rate (i.e., how many times the display updates per second) is not in synchronization with the frames per second (FPS). VSync signals may synchronize the display pipeline (e.g., the pipeline including application rendering, compositor, and a hardware composer (HWC) that presents images on the display). For instance, VSync signals may help to synchronize the time in which applications wake up to start rendering, the time the compositor wakes up to composite the screen, and the display refresh cycle. This synchronization may help to eliminate display refresh issues and improve visual performance. In some examples, the HWC may generates VSync events/signals and send the events/signals to the compositor.

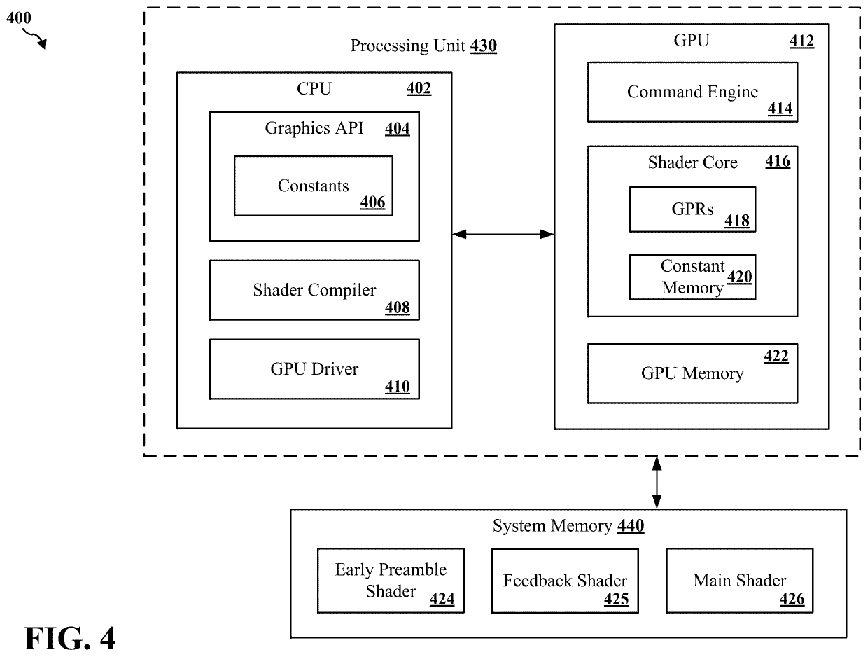

FIG. 4 is a diagram 400 that illustrates processing components, such as a processing unit 430 and the system memory 440, as may be identified in connection with a device for processing data. In aspects, the processing unit 430 may include a CPU 402 and a GPU 412. The GPU 412 and the CPU 402 may be formed as an integrated circuit (e.g., a system-on-a-chip (SOC)) and/or the GPU 412 may be incorporated onto a motherboard with the CPU 402. Alternatively, the CPU 402 and the GPU 412 may be configured as distinct processing units that are communicatively coupled to each other. For example, the GPU 412 may be incorporated on a graphics card that is installed in a port of the motherboard that includes the CPU 402.

The CPU 402 may be configured to execute a software application that causes graphical content to be displayed (e.g., on a display(s) of a device) based on one or more operations of the GPU 412. The software application may issue instructions to a graphics application program interface (API) 404, which may be a runtime program that translates instructions received from the software application into a format that is readable by a GPU driver 410. After receiving instructions from the software application via the graphics API 404, the GPU driver 410 may control an operation of the GPU 412 based on the instructions. For example, the GPU driver 410 may generate one or more command streams that are placed into the system memory 440, where the GPU 412 is instructed to execute the command streams (e.g., via one or more system calls). A command engine 414 included in the GPU 412 is configured to retrieve the one or more commands stored in the command streams. The command engine 414 may provide commands from the command stream for execution by the GPU 412. The command engine 414 may be hardware of the GPU 412, software/firmware executing on the GPU 412, or a combination thereof. While the GPU driver 410 is configured to implement the graphics API 404, the GPU driver 410 is not limited to being configured in accordance with any particular API. The system memory 440 may store the code for the GPU driver 410, which the CPU 402 may retrieve for execution. In examples, the GPU driver 410 may be configured to allow communication between the CPU 402 and the GPU 412, such as when the CPU 402 offloads graphics or non-graphics processing tasks to the GPU 412 via the GPU driver 410.

The system memory 440 may further store source code for one or more of an early preamble shader 424, a feedback shader 425, or a main shader 426. In such configurations, a shader compiler 408 executing on the CPU 402 may compile the source code of the shaders 424-426 to create object code or intermediate code executable by a shader core 416 of the GPU 412 during runtime (e.g., at the time when the shaders 424-426 are to be executed on the shader core 416). In some examples, the shader compiler 408 may pre-compile the shaders 424-426 and store the object code or intermediate code of the shader programs in the system memory 440. The shader compiler 408 (or in another example the GPU driver 410) executing on the CPU 402 may build a shader program with multiple components including the early preamble shader 424, the feedback shader 425, and the main shader 426. The main shader 426 may correspond to a portion or the entirety of the shader program that does not include the early preamble shader 424 or the feedback shader 425. The shader compiler 408 may receive instructions to compile the shader(s) 424-426 from a program executing on the CPU 402. The shader compiler 408 may also identify constant load instructions and common operations in the shader program for including the common operations within the early preamble shader 424 (rather than the main shader 426). The shader compiler 408 may identify such common instructions, for example, based on (presently undetermined) constants 406 to be included in the common instructions. The constants 406 may be defined within the graphics API 404 to be constant across an entire draw call. The shader compiler 408 may utilize instructions such as a preamble shader start to indicate a beginning of the early preamble shader 424 and a preamble shader end to indicate an end of the early preamble shader 424. Similar instructions may be used for the feedback shader 425 and the main shader 426. The feedback shader 425 will be described in further detail below.

The shader core 416 included in the GPU 412 may include general purpose registers (GPRs) 418 and constant memory 420. The GPRs 418 may correspond to a single GPR, a GPR file, and/or a GPR bank. Each GPR in the GPRs 418 may store data accessible to a single thread. The software and/or firmware executing on GPU 412 may be a shader program 424-426, which may execute on the shader core 416 of GPU 412. The shader core 416 may be configured to execute many instances of the same instructions of the same shader program in parallel. For example, the shader core 416 may execute the main shader 426 for each pixel that defines a given shape. The shader core 416 may transmit and receive data from applications executing on the CPU 402. In examples, constants 406 used for execution of the shaders 424-426 may be stored in a constant memory 420 (e.g., a read/write constant RAM) or the GPRs 418. The shader core 416 may load the constants 406 into the constant memory 420. In further examples, execution of the early preamble shader 424 or the feedback shader 425 may cause a constant value or a set of constant values to be stored in on-chip memory such as the constant memory 420 (e.g., constant RAM), the GPU memory 422, or the system memory 440. The constant memory 420 may include memory accessible by all aspects of the shader core 416 rather than just a particular portion reserved for a particular thread such as values held in the GPRs 418.

In recent years, vehicle manufacturers have been developing vehicles with assisted driving and/or autonomous driving capabilities. Assisted driving, which may also be called advanced driver assistance systems (ADAS), may refer to a set of technologies designed to enhance vehicle safety and improve the driving experience by providing assistance and automation to the driver. These technologies may use various sensor(s), such as camera(s), ranging devices(s), etc., and other components to monitor a vehicle's surroundings and assist the driver of the vehicle with certain driving tasks. For example, some features of assisted driving systems may include: (1) adaptive cruise control (ACC) (e.g., a system that automatically adjusts a vehicle's speed to maintain a safe following distance from the vehicle ahead), (2) lane-keeping assist (LKA) (e.g., a system that uses cameras to detect lane markings and helps keep the vehicle centered within the lane, and provides steering inputs to prevent unintentional lane departure), (3), autonomous emergency braking (AEB) (e.g., a system that detects potential collisions with obstacles or pedestrians and automatically apply the brakes to avoid or mitigate the impact), (4) blind spot monitoring (BSM) (e.g., a system that uses sensors to detect vehicles in a driver's blind spots and provides visual or audible alerts to avoid potential collisions during lane changes), (5) parking assistance (e.g., a system that assists drivers in parking their vehicles by using camera(s) and sensor(s) to help with parallel parking or maneuvering into tight spaces), and/or traffic sign recognition (e.g., camera(s) and image processing are used to recognize and display traffic signs such as speed limits, stop signs, and other road regulations on the vehicle's dashboard).

Autonomous driving, which may also be called as self-driving or driverless technology, may refer to the ability of a vehicle to navigate and operate itself without specifying human intervention (e.g., travelling from one place to another place without a human controlling the vehicle). The goal of the autonomous driving is to create vehicles that are capable of perceiving their surroundings, making decisions, and controlling their movements, all without the direct involvement of a human driver. To achieve or improve the autonomous driving, a vehicle may be specified to use a map (or map data) with detailed information, such as a high-definition (HD) map. An HD map may refer to a highly detailed and accurate digital map designed for use in autonomous driving and ADAS. In one example, HD maps may typically include one or more of: (1) geometric information (e.g., precise road geometry, including lane boundaries, curvature, slopes, and detailed 3D models of the surrounding environment), (2) lane-level information (e.g., information about individual lanes on the road, such as lane width, lane type (e.g., driving, turning, or parking lanes), and lane connectivity), (3) road attributes (e.g., data on road features like traffic signs, signals, traffic lights, speed limits, and road markings), (4) topology (e.g., information about the relationships between different roads, intersections, and connectivity patterns), (5) static objects (e.g., locations and details of fixed objects along the road, such as buildings, traffic barriers, and poles), (6) dynamic objects (e.g., real-time or frequently updated data about moving objects, like other vehicles, pedestrians, and cyclists), and/or (7) localization and positioning: precise reference points and landmarks that help in accurate vehicle localization on the map, etc.

Note while some assisted/autonomous driving systems may demand the use of HD map data, there are also assisted/autonomous driving systems and information systems that may be configured not to use HD map data (e.g., due to costs). For example, the Society of Automotive Engineers (SAE) has defined six levels of driving automation, from Level 0 (no automation) to Level 5 (full automation). For Level 0 (no automation), the human driver may be responsible for all aspects of driving, and the system may provide warnings or momentary assistance but does not take control of the vehicle. Example features for SAE Level 0 may include automatic emergency braking, blind spot warnings, and lane departure warnings, etc. As such, SAE Level 0 may not specify using HD map data. For Level 1 (driver assistance), the vehicle may assist with either steering or acceleration/deceleration (but may not perform both simultaneously). The human driver is still responsible for most driving tasks and may need to be ready to take over at any time. Example features for SAE Level 1 may include adaptive cruise control or lane-keeping assistance (e.g., lane centering), etc. For Level 2 (partial automation), the vehicle may control both steering and acceleration/deceleration under certain conditions, but the human driver is requested to remain engaged and monitor the driving environment at all times. Example features for SAE Level 2 may include ADAS, adaptive cruise control and lane-keeping assistance at the same time, etc. For Level 3 (conditional automation), the vehicle may perform all driving tasks under specific conditions, and the human driver may not be specified to monitor the environment but may need to be ready to take over when requested by the system. Example features for SAE Level 3 may include traffic jam chauffeur, where the vehicle is capable of handling driving in traffic jams without driver intervention. For Level 4 (high automation), the vehicle is capable of handling all driving tasks within certain conditions or environments (geofenced areas). The system may operate without human intervention but may specify a human driver outside its operational domain. Example features for SAE Level 4 may include local driverless taxi and pedals/steering, etc. For Level 5 (full automation), the vehicle is capable of performing all driving tasks under all conditions, and does not specify the human driver at any time. Example features for SAE Level 5 may include fully autonomous vehicles with no steering wheel or pedals. In summary, SAE Level 0 may be defined as features to provide warnings and assistance. ADAS is usually SAE Level 1 and 2, while AD is considered SAE level 3 to 5. Aspects presented herein (described below) may apply to all levels of SAE, including SAE Level 0 (e.g., for speed warning). For purposes of the present disclosure, a system or information system that is used in associated with SAE Level 0 to Level 5 may collectively be referred to as a “vehicle system,” which may encompass the assisted driving and the autonomous driving.

To enable a vehicle to be capable of providing assisted driving and/or autonomous driving, the vehicle may be configured to use various machine learning (ML) and/or neural network (NN) frameworks. An ML/NN framework may refer to a set of tools, libraries, and/or software components that are configured to provide a structured way to design, build, and deploy ML/NN models and applications. These frameworks may be able to simplify the process of developing ML/NN algorithms and applications by providing a foundation of pre-built functions, algorithms, and utilities. They may typically include features for data preprocessing, model training, evaluation, and/or deployment, etc. ML/NN frameworks may come in various programming languages, and they may be configured to cater to different types of machine learning tasks, including supervised learning, unsupervised learning, and/or reinforcement learning, etc. An ML/NN model may refer to a mathematical representation of a real-world process or problem, created using ML/NN algorithms and techniques. These ML/NN models may be configured to make predictions, classify data, and/or solve specific tasks based on patterns and relationships learned from input data. A deep learning framework may refer to a specialized software library or toolset that provides specified components and abstractions for building, training, and deploying deep neural networks. Deep learning frameworks may be designed to facilitate the development of complex neural network models, especially deep neural networks with multiple layers. These frameworks may offer a wide range of pre-implemented layers, optimizers, loss functions, and other components, making it easier for researchers and developers to work with deep learning models.

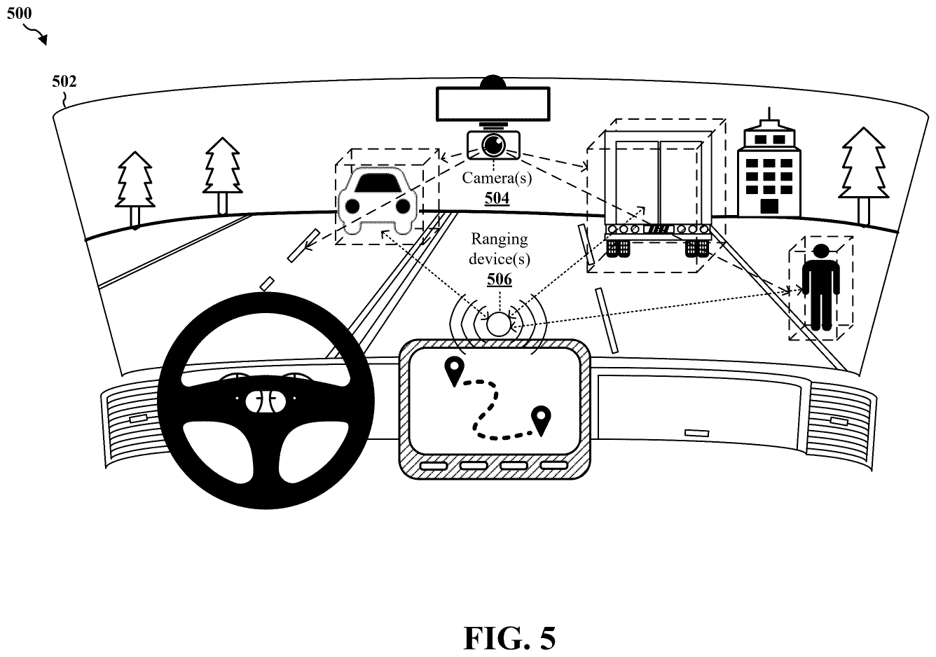

FIG. 5 is a diagram 500 illustrating an example of a vehicle performing road object detection using different types of sensors in accordance with various aspects of the present disclosure. In some implementations, a vehicle system may be configured to perform road object detections using multiple types of sensors (and also one or more ML/NN models). For purposes of the present disclosure, a road object or a traffic participant may refer to an object that is related to roads and driving, and is typically/commonly used/considered by the vehicle system in providing assisted driving or performing autonomous driving. In some examples, the road object/traffic participant may also be referred to as a traffic-related object. For example, a road object/traffic participant may be another vehicle, a pedestrian, a cyclist/bicycle, an animal, a traffic cone, a traffic sign, a traffic light, traffic, a traffic lane, a traffic line, a vulnerable road user (VRU), an object that is within a threshold distance of the vehicle, and/or any objects that may typically present on the roads (e.g., on the driving paths of vehicles), etc. On the other hand, a non-road object or a non-traffic participant (which may also be referred to as a non-traffic related object) may refer to an object that is not related to roads and driving, and is typically/commonly not used/considered by the vehicle system in providing assisted driving or performing autonomous driving. For example, a non-road object/non-traffic participant may be an object that is not within a threshold distance of the vehicle (e.g., a house on the side of the road, a mountain that is far away), an object that is not typically presented on a driving path/road (a flying object, a fire hydrant, a tree, etc.), a structure that is typically not traversed by vehicles (e.g., a pedestrian bridge), etc. An ML/NN model may be trained to identify whether an object is a road object or a non-road object.

For example, as shown by the diagram 500, a vehicle or a vehicle system (collectively as a “UE 502”) may be configured to use different types of sensors, such as a set of cameras 504 and/or a set of ranging devices 506 for detecting road objects. For purposes of the present disclosure, the term “ranging device” may broadly refer to a device/component that is capable of detecting at least the presence and/or the distance of a physical object. Examples of ranging devices may include an RF ranging device, a sonar, an ultrasonic sensor, a light detection and ranging device, etc. In some implementations, the UE 502 may also use different MN/NN models for identifying different types of road objects. For example, a first ML/NN model may be trained/used to detect and track polylines from sensor output(s) (e.g., images captured by the camera(s) of the vehicle, point clouds generated from ranging devices, etc.), while a second ML/NN model may be trained/used to detect and track objects in a three-dimensional (3D) space (e.g., to perform 3D object detection (3DOD) tasks). Then, the outputs of different types of sensors (e.g., from the set of cameras 504 and the set of ranging devices 506) may be processed and used by the ADAS or the autonomous driving system (e.g., for assisted/autonomous driving). A point cloud may refer to a discrete set of data points in space, where these points may represent a 3D shape or object. In some implementations, each point position may be associated with a set of Cartesian coordinates (X, Y, Z). Point clouds may be produced by ranging devices by detecting multiple points on the external surfaces of objects.

As described in connection with FIG. 5, various applications (e.g., use cases) such as assisted driving and/or autonomous driving, may specify the use of map data. To keep the map data up-to-date, these applications (or devices running these applications) may be configured to download updated map data from a server from time to time or based on certain pre-defined conditions (e.g., when travelling to an area that is without map data). In some implementations, downloading map data from a server may be referred to as “map over the air” (MOTA).

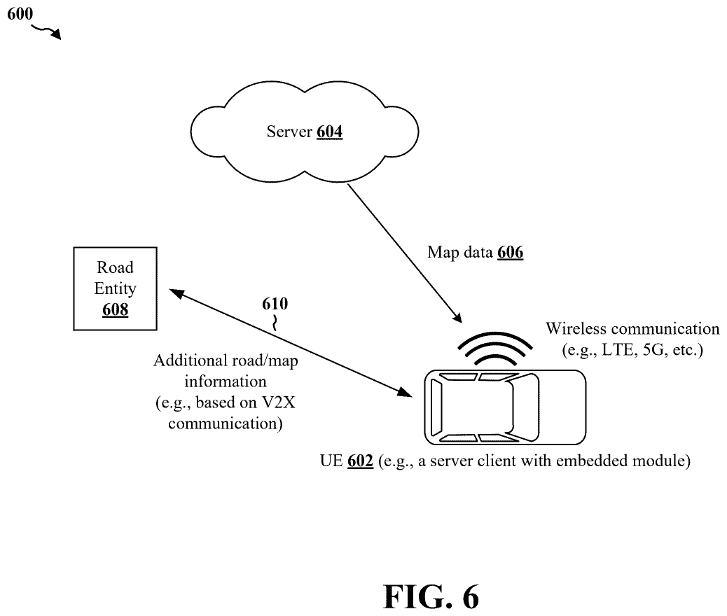

FIG. 6 is a diagram 600 illustrating an example of a vehicle performing map over the air in accordance with various aspects of the present disclosure. In one example, map over the air may refer to a process of a server 604 sending (real-time) map data 606 to a UE 602 (e.g., a vehicle, a vehicle system, an on-board unit (OBU) of the vehicle, a device running a navigation application, etc.) over a wireless network/communication (e.g., an LTE network, a 5G network, etc.), enabling the UE 602 to make decisions based on the latest information about the road and traffic conditions. Depending on implementations and conditions, different amount of map data 606 may be downloaded by the UE 602 from the server 604. For example, in some scenarios, the UE 602 may be configured to (1) download map data before driving, (2) download just updates for road conditions (e.g., traffic jams, construction work, etc.) while driving, (3) continuously download updated map data whenever available, or (4) a combination thereof (e.g., the UE 602 may download map data before driving, and continuously to download the updates while driving, including changes in map data (e.g., newly opened or closed street/highway, short term construction work). In some scenarios, the UE 602 may also be configured to stream the map data 606, which means the UE 602 does not download the map data before driving (e.g., the map data is streamed in real-time while the UE 602 is driving).

In an example implementation, the map data 606 is transmitted from the server 604 (e.g., a cloud-based system), where the server 604 may utilize sensors and other data sources to collect and analyze information about the road network and traffic patterns. For example, the server 604 may receive and gather traffic/road information provided by a group of UEs (e.g., vehicles, roadside units (RSUs), etc.). In some examples, the information/data collected by a server from multiple UEs may be referred to as “fleet data” or “crowdsourced/crowdsourcing data.” This data may be processed and combined with other data, such as GPS/GNSS and/or camera data from multiple users (e.g., from other UEs/vehicles and/or the UE 602) to create a detailed map of the environment in real-time. Then, an application (e.g., for autonomous driving, navigation, positioning, etc.) of the UE 602 may access the map data 606 over a wireless network (e.g., a cellular or satellite network), and use the map data 606 to make decisions about speed, route, and other factors, etc. For example, the UE 602 may use the map data 606 to avoid road construction, traffic congestion, or accidents, and to optimize its route for efficiency and safety, etc. In some examples, as shown at 610, the UE 602 may also be configured to receive (additional) road/map information from another road entity 608, such as from another vehicle/UE, a roadside unit (RSU), or a traffic/road infrastructure (e.g., traffic lights), such as based on vehicle-to-everything (V2X) communication protocol/technology.

Map data with lane-level information, such as road-maps with lane-level connectivity, may play a crucial role in enhancing the safety, the efficiency, and/or the overall performance of autonomous driving systems and ADAS systems, and may also contribute to the realization of a safer and more connected transportation future. For purposes of the present disclosure, a map data with lane-level information/connectivity may be referred to as a “lane-map,” a “lane-level map,” “lane-map data,” and/or “lane-level map data,” etc., which may indicate that the map data includes information related to different lanes of a road. In addition, depending on the context, the term “map data” may be used interchangeably with the term “map.”

As used herein, the term “processing core” or “BIST core” may refer to a unit within a processing unit (e.g., a CPU or a GPU) that performs computation and processes instructions where each core may independently execute tasks by reading and executing program instructions. Each processing core may all have access to a memory, such as a cache, which may store data. As used herein, the term “cluster,” “a set of processing cores,” or “a subset of processing cores,” may refer to a group of processing cores that share some resources, such as cache memory or power management features. The clusters may communicate with each other, via a high-speed interconnect or bus, to share data across the entire CPU, which may enable coordinated multitasking. A particular processing core or a set of processing cores may be “functional,” which may be operational and fully capable of executing instructions, handling tasks, and performing computations. A particular processing core or a set of processing cores may be “non-functional,” which may be disabled, faulty, in a standby mode, or otherwise unable to execute certain instructions. In some aspects, a device may fuse or completely turn off non-functional cores or underperforming cores. As used herein, the term “bypass” may refer to skipping BIST when other cores are subject to BIST.

As used herein, the term “built-in self-test (BIST)” may refer to a scheme that enables a component, such as a CPU or a GPU, to test itself automatically without external testing equipment. BIST may generate test patterns or stimuli and then apply these to various parts of the component (e.g., logic gates, memory cells, interconnections) to check for issues that may develop over a period of time when the device is in use, such as non-functional processing cores. In some aspects, a BIST may involve multi-phase tests. In some aspects, there may be on chip test pattern stored in ROM which test various device configurations where a device may be capable of turning off a function or unable to turning off the function. The test pattern may be agnostic to specific device configuration or the device's capability with regard to turning off a function by fusing certain cores.

System-on-chips (SOCs) may be mainly a multi-processing core. The concept of fusing or completely turning off non-functional cores or underperforming cores may be a process used for isolating faulty logic for ensuring proper operation of the SoC. Aspects provided herein may enable a built-in self-test (BIST) for identifying non-functional cores. In general, aspects provided herein may involve a hardware control unit where sequences are encoded from the start based on power on configuration at a hardware BIST control unit (HBCU). The HBCU may generate phase-wise control signals based on the sequences. Based on the boot core and boot cluster information, each BIST core may be mapped to corresponding phase signals. Mask signals may be generated based on which BIST core may be subject to disable or fuse. Logic BIST (LBIST) memory BIST (MBIST) gating based on the mask signals may be used to handle a toggle rate. BIST pass/fail status generation may be based on disable/fuse, boot core, and boot cluster values. The disable/fuse values may represent which cores to disable/fuse, the boot core values may represent which cores may be used for booting, and the boot cluster values may represent the programmable value stored in fuses associated with a specific cluster of cores. Boot cluster fuse may include information about which subset of the multiple groups of cores contains the boot core.

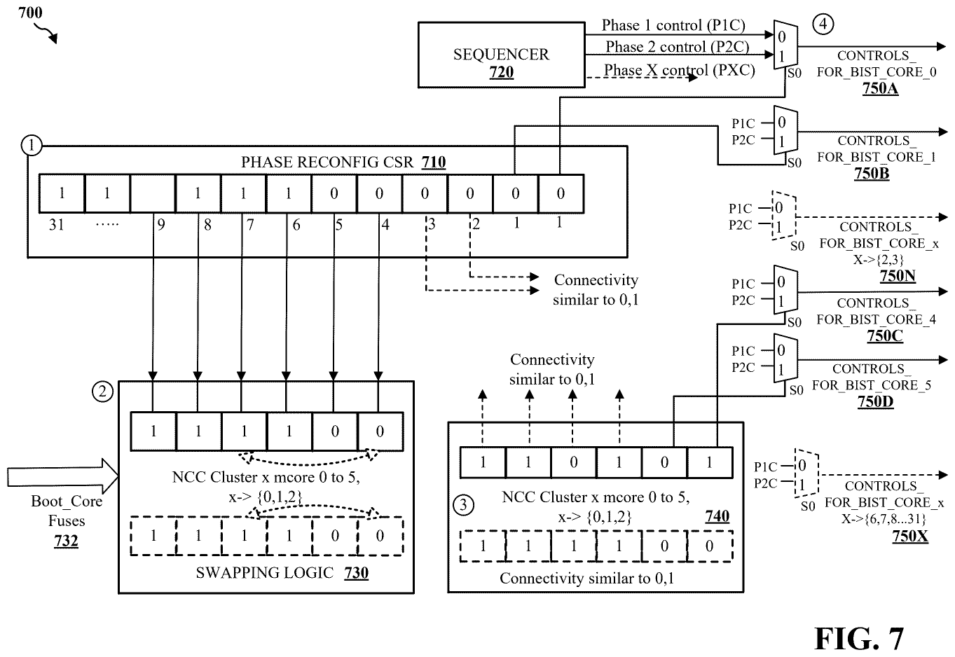

FIG. 7 is a diagram 700 illustrating an example of a disable or fuse-based phase remapping for control signals. As illustrated in FIG. 7, in a phase reconfiguration control and status register, phase reconfiguration CSR 710, a set of power-on reset (POR) values of the phase reconfiguration CSR indicating which phase the X^{th} BIST core will be BISTED (e.g., subject to BIST). A CSR may be a register that allows for dynamic adjustment and control of phase-related parameters within a HBCU. The phase reconfiguration CSR 710 may be a dedicated register within a HBCU that can store control commands and real-time status information (e.g., in the form of POR values) and may be holding commands and settings that control the phase of internal signals or clocks within the HBCU. The POR values that indicate which phase the X^{th} BIST core will be BISTED may be used as input for a swapping logic component 730. By default, core 0 may be considered a boot core. If the boot core is subject to fuse or disable changed based on boot core fuses information 732 and the POR values that indicate which phase the X^{th} BIST core will be BISTED, the data between the boot core register and the 0^{th} register may be swapped by the swapping logic component 730. At 740, the new phase reconfiguration based on the POR values that indicates which phase the X^{th} BIST core will be BISTED may be registered and given to the further logic.

In some aspects, a sequencer 720 may regenerate phase-wise signals and then the HBCU may convert the phase-wise signals to cluster wise control based on the new phase reconfiguration based on the values generated at 740. A sequencer may be a component that is responsible for generating and controlling a specific sequence of operations or events within the processor, such as order control (e.g., order of operations), timing management (e.g., timing signals or clocks to synchronize different parts of the processor), transitions between different states, or pipeline control. The generated phase control signal may be masked by the bypass signals. A series of multiplexers may be used to generate a series of control signals for BIST cores. For example, a first control signal 750A may be generated for a first BIST core, a second control signal 750B may be generated for a second BIST core, a third control signal 750N may be generated for a subset of BIST cores including a third and a fourth BIST core, a fourth control signal 750C may be generated for a fifth BIST core, a fifth control signal 750D may be generated for a sixth BIST core, and a sixth control signal 750X may be generated for a remaining set of BIST cores including the seventh BIST core to the thirty second BIST core. In some aspects, there may be less control signals generated.

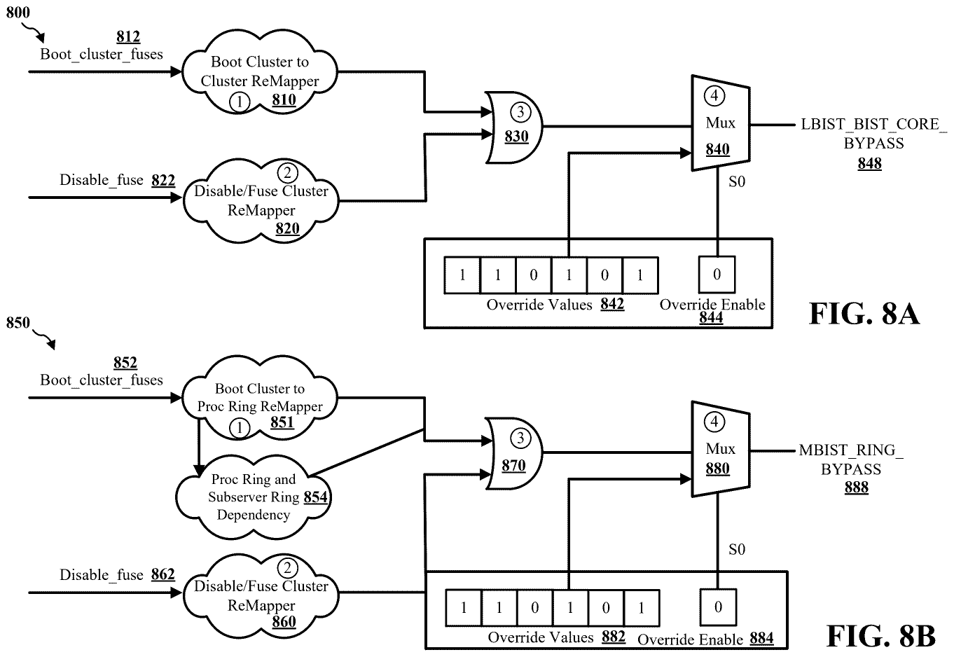

FIG. 8A is a diagram 800 illustrating an example of a disable or fuse-based core bypass control. A set of boot cluster fuses 812 may be used as an input for a boot cluster to cluster remapper 810 that may be responsible for bypassing the non-boot clusters for the processor. Cores inside a non-boot cluster may be bypassed by the boot cluster to cluster remapper 810. If the core is subject to disable/fuse based on disable fuse values 822, then the core may be bypassed by the disable/fuse cluster remapper 820. The result of both the disable/fuse cluster remapper 820 and the boot cluster to cluster remapper 810 may be OR′ed at 830 and passed through the multiplexer 840 which may enable flexibility for overriding via software entity based on overriding values 842 and override enable 844. The multiplexer 840 may generate LBIST_BIST_CORE_BYPASS 848 which may be negated and given to an entity, such as an application processor sub-system (APSS) as active cores (which are the cores to be tested via hardware).

FIG. 8B is a diagram 850 illustrating another example of a disable or fuse-based core bypass control. A set of boot cluster fuses 852 may be used as input for a boot cluster to cluster remapper 851 that may be responsible for switching the boot clusters for the processor. The boot cluster to cluster remapper 851 may communicate with a processor ring and subserver ring dependency 854, which may resolve dependency between processor and subserver rings. If the core is subject to disable/fuse based on disable fuse values 862, then the core may be bypassed by the disable/fuse cluster remapper 860. The result of both the disable/fuse cluster remapper 860 and the boot cluster to cluster remapper 851 may be OR′ed at 870 and passed through the multiplexer 880 which may enable flexibility for overriding via software entity based on overriding values 882 and override enable 884. The multiplexer 880 may generate LBIST_BIST_CORE_BYPASS 888 which may be negated and given to an entity, such as an APSS as active cores (which are the cores to be tested via hardware).

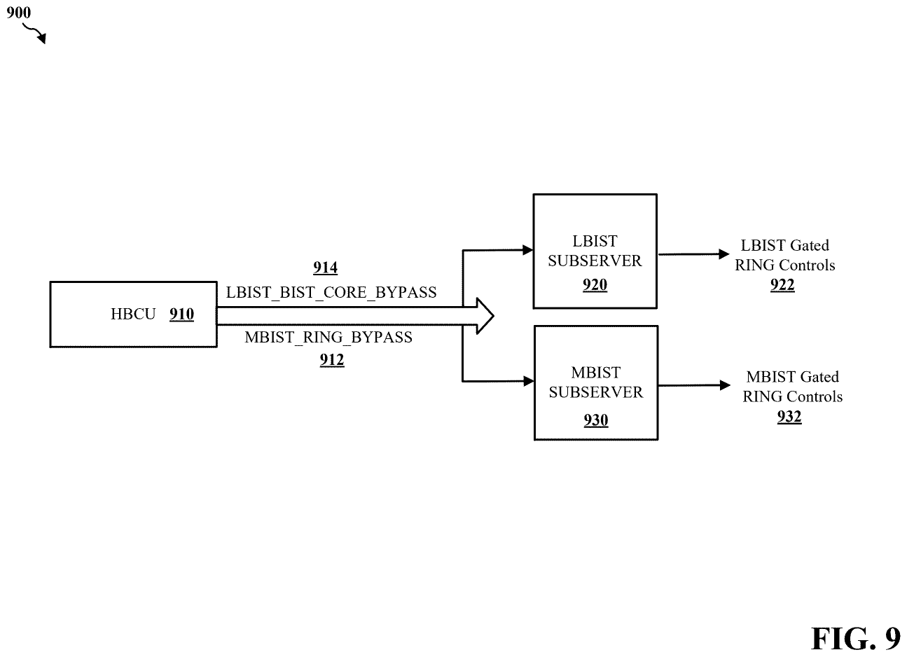

FIG. 9 is a diagram 900 illustrating an example of ring gating at a sub-system level. As illustrated in FIG. 9, an HBCU 910 may generate LBIST_BIST_CORE_BYPASS values 914 indicating cores to bypass in LBIST and MBIST_BIST_RING_BYPASS values 912 indicating cores/rings to bypass in MBIST, which may be used as an input for MBIST subserver 930 and LBIST subserver 920 to respectively generate LBIST gated ring controls 922 and MBIST gated ring controls 932.

The autonomous in-system test (AIT) broadcasts the patterns stored in on-chip ROM and the data to XLBIST controller may be qualified with MCOR gating.

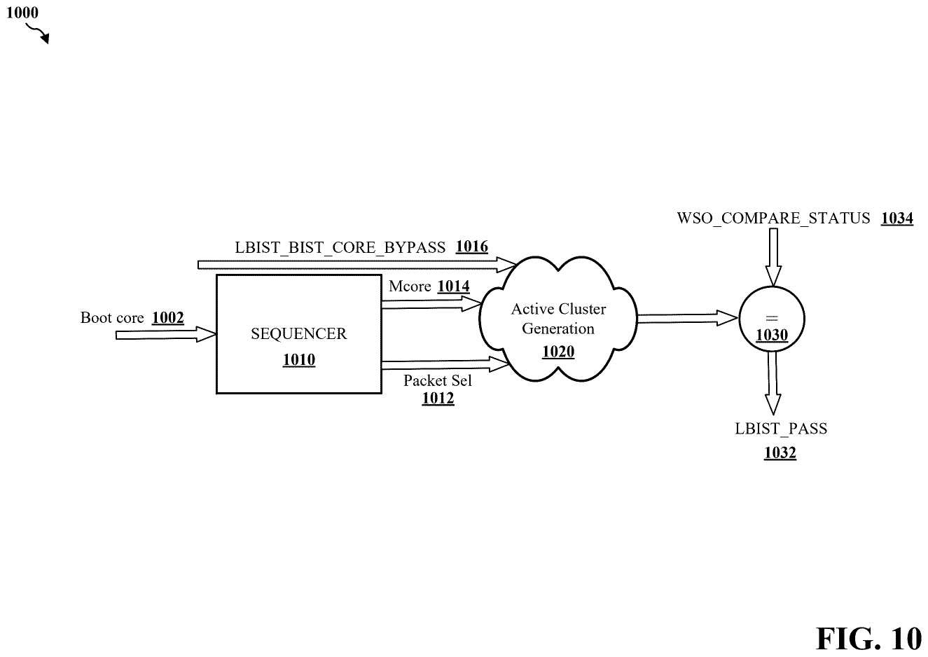

FIG. 10 is a diagram 1000 illustrating an example of logic BIST (LBIST) logic manipulation using the bypass data. A sequencer 1010 may take boot core information 1002 as an input from fuses and generate MCOR data 1014 based on the current phase and other information. The MCOR data 1014 may indicate which of the cores is undergoing LBIST. At 1020, the bypass information 1016 generated by bypass controller, MCOR, and the current packet 1012 may be used to generate the information about the cores that are undergoing BIST in real time. At 1030, the information about the cores that are undergoing BIST in real time is compared with WSO_COMPARE_STATUS 1034, which includes pass fail information about individual cores and the final LBIST pass status 1032 may be generated, which may indicate cores that passed the LBIST.

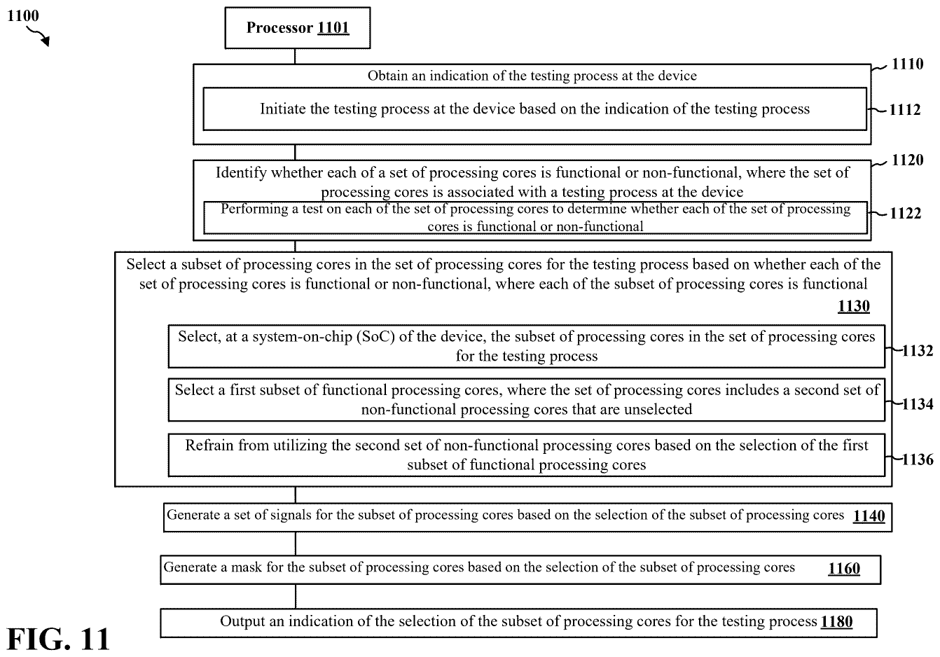

FIG. 11 is a diagram 1100 illustrating example procedures at a processor 1101 to perform built-in self-test (BIST). At 1110, the processor 1101 may obtain an indication of the testing process at the processor 1101, where the testing process is associated with the set of processing cores.

At 1112, the processor 1101 may initiate the testing process at the processor 1101 based on the indication of the testing process.

In some aspects, the testing process includes data for the testing process or a set of vectors for the testing process, and the processor 1101 may store, at the processor 1101, the data for the testing process or the set of vectors for the testing process. In some aspects, the testing process is a self-testing process at the processor 1101, a built-in self-test (BIST) process at the processor 1101, or a hardware-enabled BIST at the processor 1101.

At 1120, the processor 1101 may identify whether each of a set of processing cores is functional or non-functional, where the set of processing cores is associated with a testing process at the processor 1101.

In some aspects, to identify whether each of the set of processing cores is functional or non-functional, at 1122, the processor 1101 may obtain an indication of whether each of the set of processing cores is functional or non-functional. In some aspects, to identify whether each of the set of processing cores is functional or non-functional, the processor 1101 may perform a test on each of the set of processing cores to identify whether each of the set of processing cores is functional or non-functional. In some aspects, to perform the test on each of the set of processing cores, the processor 1101 may perform a multiple phase test on each of the set of processing cores to identify whether each of the set of processing cores is functional or non-functional, where a first phase of the multiple phase test includes a test for at least one first processing core in the set of processing cores and a second phase of the multiple phase test includes a test for at least one second processing core in the set of processing cores.

At 1130, the processor 1101 may select a subset of processing cores in the set of processing cores for the testing process based on whether each of the set of processing cores is functional or non-functional, where each of the subset of processing cores is functional.

In some aspects, to select the subset of processing cores for the testing process, at 1132, the processor 1101 may select, at a SoC of the processor 1101, the subset of processing cores in the set of processing cores for the testing process.

In some aspects, to select the subset of processing cores for the testing process, at 1134, the processor 1101 may select a first subset of functional processing cores, where the set of processing cores includes a second set of non-functional processing cores that are unselected.

In some aspects, to select the subset of processing cores for the testing process, at 1136, the processor 1101 may refrain from utilizing the second set of non-functional processing cores based on the selection of the first subset of functional processing cores. In some aspects, to refrain from utilizing the second set of non-functional processing cores, the processor 1101 may disable all of the second set of non-functional processing cores based on the selection of the first subset of functional processing cores.

At 1140, the processor 1101 may generate a set of signals for the subset of processing cores based on the selection of the subset of processing cores. In some aspects, the processor 1101 may map, based on the generation of the set of signals, each of the set of signals to each of the subset of processing cores. In some aspects, the set of signals for the subset of processing cores is a set of phase-wise control signals for the subset of processing cores.

At 1160, the processor 1101 may generate a mask for the subset of processing cores based on the selection of the subset of processing cores, where the mask for the subset of processing cores includes a set of mask signals for the subset of processing cores In some aspects, to generate the mask, the processor 1101 may generate the mask for the subset of processing cores for a first logic testing process and a second memory testing process and store the mask for the subset of processing cores for the first logic testing process and the second memory testing process.

In some aspects, the processor 1101 may determine whether to overwrite the mask for the first logic testing process and the second memory testing process based on a debugging process and overwrite the mask for the first logic testing process and the second memory testing process based on the debugging process.

At 1180, the processor 1101 may output an indication of the selection of the subset of processing cores for the testing process. In some aspects, to output the indication of the selection of the subset of processing cores for the testing process, the processor 1101 may initiate the testing process at the processor 1101 including the subset of processing cores, transmit the indication of the selection of the subset of processing cores for the testing process, or store the indication of the selection of the subset of processing cores for the testing process.

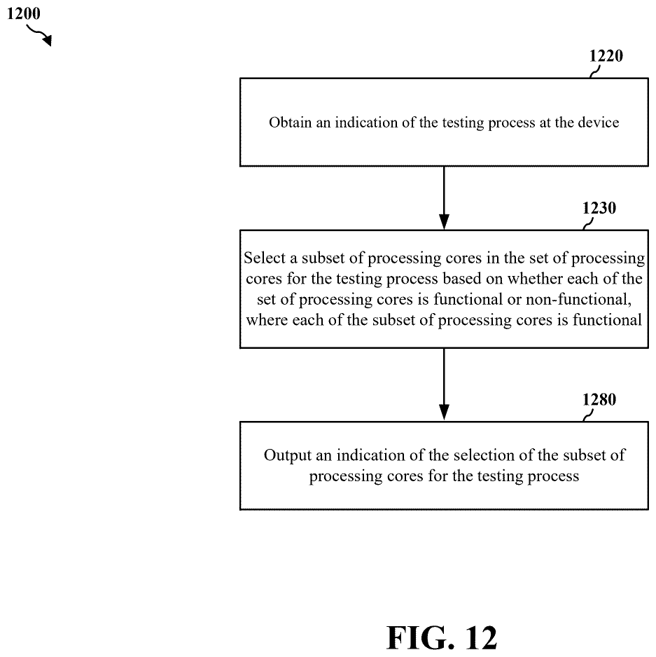

FIG. 12 is a flowchart 1200 of a method of wireless communication. The method may be performed by a device (e.g., the UE 104, a device that includes the processor 1101, the apparatus 1404).

At 1220, the device may identify whether each of a set of processing cores is functional or non-functional, where the set of processing cores is associated with a testing process at the device. For example, the processor 1101 may, at 1120, identify whether each of a set of processing cores is functional or non-functional, where the set of processing cores is associated with a testing process at the device. In some aspects, 1220 may be performed by testing component 198.

At 1230, the device may select a subset of processing cores in the set of processing cores for the testing process based on whether each of the set of processing cores is functional or non-functional, where each of the subset of processing cores is functional. For example, the processor 1101 may, at 1130, select a subset of processing cores in the set of processing cores for the testing process based on whether each of the set of processing cores is functional or non-functional, where each of the subset of processing cores is functional. In some aspects, 1230 may be performed by testing component 198.

At 1280, the device may output an indication of the selection of the subset of processing cores for the testing process. For example, the processor 1101 may, at 1180 output an indication of the selection of the subset of processing cores for the testing process. In some aspects, 1280 may be performed by testing component 198.

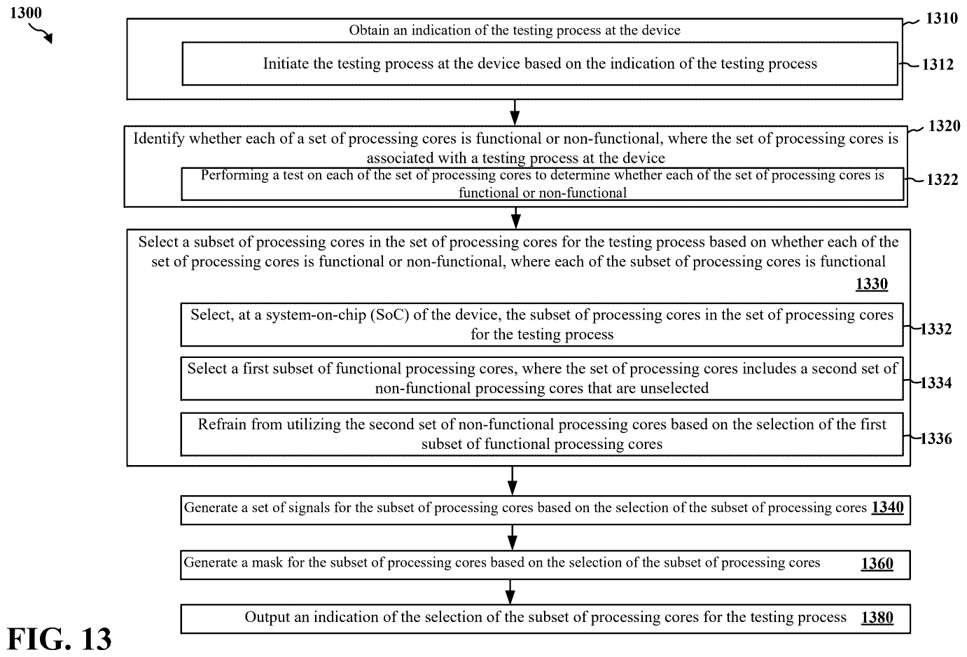

FIG. 13 is a flowchart 1300 of a method of a testing process. The method may be performed by a device (e.g., the UE 104, a device that includes the processor 1101, the apparatus 1404).

At 1310, the device may obtain an indication of the testing process at the device, where the testing process is associated with the set of processing cores. For example, the processor 1101 may, at 1110 obtain an indication of the testing process at the device, where the testing process is associated with the set of processing cores. In some aspects, 1310 may be performed by testing component 198.

At 1312, the device may initiate the testing process at the device based on the indication of the testing process. For example, the processor 1101 may, at 1112, initiate the testing process at the device based on the indication of the testing process. In some aspects, 1312 may be performed by testing component 198.

In some aspects, the testing process includes data for the testing process or a set of vectors for the testing process, and the device may store, at the device, the data for the testing process or the set of vectors for the testing process. In some aspects, the testing process is a self-testing process at the device, a built-in self-test (BIST) process at the device, or a hardware-enabled BIST at the device.

At 1320, the device may identify whether each of a set of processing cores is functional or non-functional, where the set of processing cores is associated with a testing process at the device. For example, the processor 1101 may, at 1120, identify whether each of a set of processing cores is functional or non-functional, where the set of processing cores is associated with a testing process at the device. In some aspects, 1320 may be performed by testing component 198.

In some aspects, to identify whether each of the set of processing cores is functional or non-functional, at 1322, the device may obtain an indication of whether each of the set of processing cores is functional or non-functional. For example, the processor 1101 may obtain an indication of whether each of the set of processing cores is functional or non-functional. In some aspects, 1322 may be performed by testing component 198. In some aspects, to identify whether each of the set of processing cores is functional or non-functional, the device may perform a test on each of the set of processing cores to identify whether each of the set of processing cores is functional or non-functional. In some aspects, to perform the test on each of the set of processing cores, the device may perform a multiple phase test on each of the set of processing cores to identify whether each of the set of processing cores is functional or non-functional, where a first phase of the multiple phase test includes a test for at least one first processing core in the set of processing cores and a second phase of the multiple phase test includes a test for at least one second processing core in the set of processing cores.

At 1330, the device may select a subset of processing cores in the set of processing cores for the testing process based on whether each of the set of processing cores is functional or non-functional, where each of the subset of processing cores is functional. For example, the processor 1101 may, at 1130, select a subset of processing cores in the set of processing cores for the testing process based on whether each of the set of processing cores is functional or non-functional, where each of the subset of processing cores is functional. In some aspects, 1330 may be performed by testing component 198.

In some aspects, to select the subset of processing cores for the testing process, at 1332, the device may select, at a SoC of the device, the subset of processing cores in the set of processing cores for the testing process. For example, the processor 1101 may, at 1132, select, at a SoC of the device, the subset of processing cores in the set of processing cores for the testing process. In some aspects, 1332 may be performed by testing component 198.

In some aspects, to select the subset of processing cores for the testing process, at 1334, the device may select a first subset of functional processing cores, where the set of processing cores includes a second set of non-functional processing cores that are unselected. For example, the processor 1101 may, at 1134, select a first subset of functional processing cores, where the set of processing cores includes a second set of non-functional processing cores that are unselected. In some aspects, 1334 may be performed by testing component 198.

In some aspects, to select the subset of processing cores for the testing process, at 1336, the device may refrain from utilizing the second set of non-functional processing cores based on the selection of the first subset of functional processing cores. For example, the processor 1101, at 1136, may refrain from utilizing the second set of non-functional processing cores based on the selection of the first subset of functional processing cores. In some aspects, 1336 may be performed by testing component 198. In some aspects, to refrain from utilizing the second set of non-functional processing cores, the device may disable all of the second set of non-functional processing cores based on the selection of the first subset of functional processing cores.

At 1340, the device may generate a set of signals for the subset of processing cores based on the selection of the subset of processing cores. For example, the processor 1101 may, at 1140, generate a set of signals for the subset of processing cores based on the selection of the subset of processing cores. In some aspects, 1340 may be performed by testing component 198. In some aspects, the device may map, based on the generation of the set of signals, each of the set of signals to each of the subset of processing cores. In some aspects, the set of signals for the subset of processing cores is a set of phase-wise control signals for the subset of processing cores.

At 1360, the device may generate a mask for the subset of processing cores based on the selection of the subset of processing cores, where the mask for the subset of processing cores includes a set of mask signals for the subset of processing cores. For example, the processor 1101, at 1160 may generate a mask for the subset of processing cores based on the selection of the subset of processing cores, where the mask for the subset of processing cores includes a set of mask signals for the subset of processing cores. In some aspects, 1360 may be performed by testing component 198. In some aspects, to generate the mask, the device may generate the mask for the subset of processing cores for a first logic testing process and a second memory testing process and store the mask for the subset of processing cores for the first logic testing process and the second memory testing process.

In some aspects, the device may determine whether to overwrite the mask for the logic testing process and the memory testing process based on a debugging process and overwrite the mask for the logic testing process and the memory testing process based on the debugging process.

At 1380, the device may output an indication of the selection of the subset of processing cores for the testing process. For example, the processor 1101 may, at 1180 output an indication of the selection of the subset of processing cores for the testing process. In some aspects, 1380 may be performed by testing component 198. In some aspects, to output the indication of the selection of the subset of processing cores for the testing process, the device may initiate the testing process at the device including the subset of processing cores, transmit the indication of the selection of the subset of processing cores for the testing process, or store the indication of the selection of the subset of processing cores for the testing process.

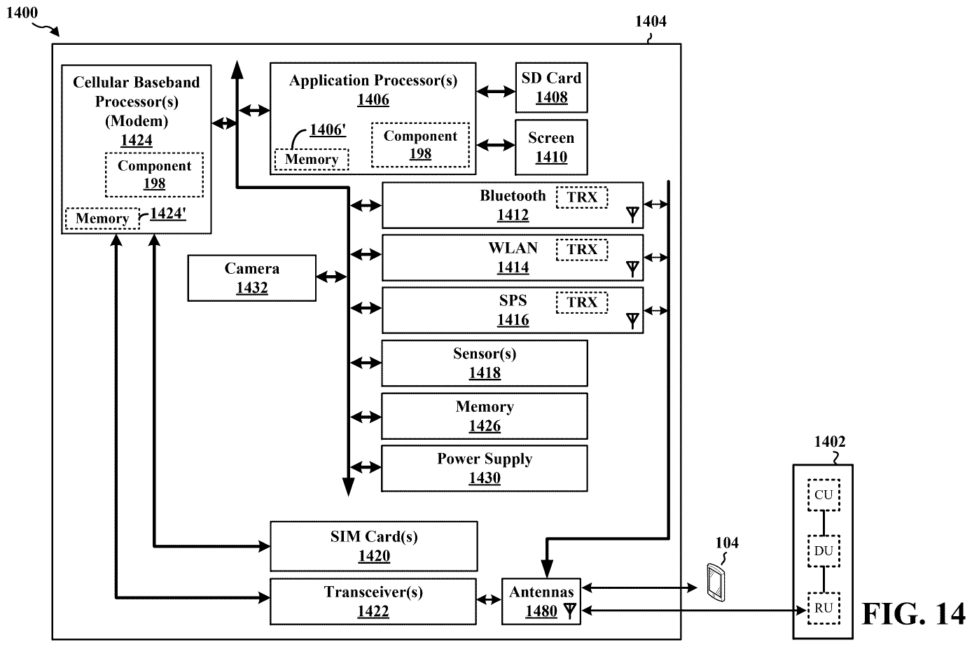

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor 1424 (also referred to as a modem) coupled to one or more transceivers 1422 (e.g., cellular RF transceiver). The cellular baseband processor(s) 1424 may include at least one on-chip memory 1424′. In some aspects, the apparatus 1404 may further include one or more subscriber identity modules (SIM) cards 1420 and at least one application processor 1406 coupled to a secure digital (SD) card 1408 and a screen 1410. The application processor(s) 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); ranging devices, magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor(s) 1424 communicates through the transceiver(s) 1422 via one or more antennas 1480 with the UE 104 and/or with an RU associated with a network entity 1402. The cellular baseband processor(s) 1424 and the application processor(s) 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor(s) 1424 and the application processor(s) 1406 are each responsible for general processing, including the execution of software stored on the computer-readable medium/memory. The software, when executed by the cellular baseband processor(s) 1424/application processor(s) 1406, causes the cellular baseband processor(s) 1424/application processor(s) 1406 to perform the various functions described supra. The computer-readable medium/memory may also be used for storing data that is manipulated by the cellular baseband processor(s) 1424/application processor(s) 1406 when executing software. The cellular baseband processor(s) 1424/application processor(s) 1406 may be a component of the UE 350 and may include the at least one memory 360 and/or at least one of the TX processor 368, the RX processor 356, and the controller/processor 359. In one configuration, the apparatus 1404 may be at least one processor chip (modem and/or application) and include just the cellular baseband processor(s) 1424 and/or the application processor(s) 1406, and in another configuration, the apparatus 1404 may be the entire UE (e.g., see UE 350 of FIG. 3) and include the additional modules of the apparatus 1404.

As discussed supra, the testing component 198 may be configured to identify whether each of a set of processing cores is functional or non-functional, where the set of processing cores is associated with a testing process at the device. In some aspects, the testing component 198 may be further configured to select a subset of processing cores in the set of processing cores for the testing process based on whether each of the set of processing cores is functional or non-functional, where each of the subset of processing cores is functional. In some aspects, the testing component 198 may be further configured to output an indication of the selection of the subset of processing cores for the testing process. The testing component 198 may be within the cellular baseband processor(s) 1424, the application processor(s) 1406, or both the cellular baseband processor(s) 1424 and the application processor(s) 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) 1424 and/or the application processor(s) 1406, may include means for identifying whether each of a set of processing cores is functional or non-functional, where the set of processing cores is associated with a testing process at the device. In some aspects, the apparatus 1404 may include means for selecting a subset of processing cores in the set of processing cores for the testing process based on whether each of the set of processing cores is functional or non-functional, where each of the subset of processing cores is functional. In some aspects, the apparatus 1404 may include means for outputting an indication of the selection of the subset of processing cores for the testing process. In some aspects, the apparatus 1404 may include means for obtaining an indication of the testing process at the device, where the testing process is associated with the set of processing cores. In some aspects, the apparatus 1404 may include means for initiating the testing process at the device based on the indication of the testing process. In some aspects, the apparatus 1404 may include means for storing, at the device, the data for the testing process or the set of vectors for the testing process. In some aspects, the apparatus 1404 may include means for obtaining an indication of whether each of the set of processing cores is functional or non-functional. In some aspects, the apparatus 1404 may include means for performing a test on each of the set of processing cores to identify whether each of the set of processing cores is functional or non-functional. In some aspects, the apparatus 1404 may include means for performing a multiple phase test on each of the set of processing cores to identify whether each of the set of processing cores is functional or non-functional, where a first phase of the multiple phase test includes a test for at least one first processing core in the set of processing cores and a second phase of the multiple phase test includes a test for at least one second processing core in the set of processing cores. In some aspects, the apparatus 1404 may include means for selecting, at a system-on-chip (SoC) of the device, the subset of processing cores in the set of processing cores for the testing process. In some aspects, the apparatus 1404 may include means for selecting a first subset of functional processing cores, where the set of processing cores includes a second set of non-functional processing cores that are unselected. In some aspects, the apparatus 1404 may include means for refraining from utilizing the second set of non-functional processing cores based on the selection of the first subset of functional processing cores. In some aspects, the apparatus 1404 may include means for disabling all of the second set of non-functional processing cores based on the selection of the first subset of functional processing cores. In some aspects, the apparatus 1404 may include means for generating a set of signals for the subset of processing cores based on the selection of the subset of processing cores. In some aspects, the apparatus 1404 may include means for mapping, based on the generation of the set of signals, each of the set of signals to each of the subset of processing cores. In some aspects, the apparatus 1404 may include means for generating a mask for the subset of processing cores based on the selection of the subset of processing cores, where the mask for the subset of processing cores includes a set of mask signals for the subset of processing cores. In some aspects, the apparatus 1404 may include means for generating the mask for the subset of processing cores for a first logic testing process and a second memory testing process. In some aspects, the apparatus 1404 may include means for storing the mask for the subset of processing cores for the first logic testing process and the second memory testing process. In some aspects, the apparatus 1404 may include means for determining whether to overwrite the mask for the first logic testing process and the second memory testing process based on a debugging process. In some aspects, the apparatus 1404 may include means for overwriting the mask for the first logic testing process and the second memory testing process based on the debugging process. In some aspects, the apparatus 1404 may include means for initiating the testing process at the device including the subset of processing cores. In some aspects, the apparatus 1404 may include means for transmitting the indication of the selection of the subset of processing cores for the testing process. In some aspects, the apparatus 1404 may include means for storing the indication of the selection of the subset of processing cores for the testing process. The means may be the component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for communication at a device, including: at least one memory; and at least one processor coupled to the at least one memory and, based at least in part on information stored in the at least one memory, the at least one processor is configured to: identify whether each of a set of processing cores is functional or non-functional, where the set of processing cores is associated with a testing process at the device; select a subset of processing cores in the set of processing cores for the testing process based on whether each of the set of processing cores is functional or non-functional, where each of the subset of processing cores is functional; and output an indication of the selection of the subset of processing cores for the testing process.

Aspect 2 is the apparatus of aspect 1, where the at least one processor is further configured to: obtain an indication of the testing process at the device, where the testing process is associated with the set of processing cores.

Aspect 3 is the apparatus of aspect 2, where the at least one processor is further configured to: initiate the testing process at the device based on the indication of the testing process.

Aspect 4 is the apparatus of any of aspects 2-3, where the testing process includes data for the testing process or a set of vectors for the testing process, and where the at least one processor is further configured to: store, at the device, the data for the testing process or the set of vectors for the testing process.

Aspect 5 is the apparatus of any of aspects 1-4, where the testing process is a self-testing process at the device, a built-in self-test (BIST) process at the device, or a hardware-enabled BIST at the device.

Aspect 6 is the apparatus of any of aspects 1-5, where to identify whether each of the set of processing cores is functional or non-functional, the at least one processor is configured to: obtain an indication of whether each of the set of processing cores is functional or non-functional.

Aspect 7 is the apparatus of any of aspects 1-6, where to identify whether each of the set of processing cores is functional or non-functional, the at least one processor is configured to: perform a test on each of the set of processing cores to identify whether each of the set of processing cores is functional or non-functional.

Aspect 8 is the apparatus of aspect 7, where to perform the test on each of the set of processing cores, the at least one processor is configured to: perform a multiple phase test on each of the set of processing cores to identify whether each of the set of processing cores is functional or non-functional, where a first phase of the multiple phase test includes a test for at least one first processing core in the set of processing cores and a second phase of the multiple phase test includes a test for at least one second processing core in the set of processing cores.

Aspect 9 is the apparatus of any of aspects 1-8, where to select the subset of processing cores for the testing process, the at least one processor is configured to: select, at a system-on-chip (SoC) of the device, the subset of processing cores in the set of processing cores for the testing process.

Aspect 10 is the apparatus of any of aspects 1-9, where to select the subset of processing cores for the testing process, the at least one processor is configured to: select a first subset of functional processing cores, where the set of processing cores includes a second set of non-functional processing cores that are unselected.

Aspect 11 is the apparatus of aspect 10, where the at least one processor is further configured to: refrain from utilizing the second set of non-functional processing cores based on the selection of the first subset of functional processing cores.

Aspect 12 is the apparatus of aspect 11, where to refrain from utilizing the second set of non-functional processing cores, the at least one processor is configured to: disable all of the second set of non-functional processing cores based on the selection of the first subset of functional processing cores.

Aspect 13 is the apparatus of any of aspects 1-12, where the at least one processor is further configured to: generate a set of signals for the subset of processing cores based on the selection of the subset of processing cores; and map, based on the generation of the set of signals, each of the set of signals to each of the subset of processing cores.

Aspect 14 is the apparatus of aspect 13, where the set of signals for the subset of processing cores is a set of phase-wise control signals for the subset of processing cores.

Aspect 15 is the apparatus of any of aspects 1-14, where the at least one processor is further configured to: generate a mask for the subset of processing cores based on the selection of the subset of processing cores, where the mask for the subset of processing cores includes a set of mask signals for the subset of processing cores.

Aspect 16 is the apparatus of aspect 15, where to generate the mask for the subset of processing cores, the at least one processor is configured to: generate the mask for the subset of processing cores for a first logic testing process and a second memory testing process; and store the mask for the subset of processing cores for the first logic testing process and the second memory testing process, and where the at least one processor is further configured to: determine whether to overwrite the mask for the first logic testing process and the second memory testing process based on a debugging process; and overwrite the mask for the first logic testing process and the second memory testing process based on the debugging process.

Aspect 17 is the apparatus of any of aspects 1-16, where to output the indication of the selection of the subset of processing cores for the testing process, the at least one processor is configured to: initiate the testing process at the device including the subset of processing cores; transmit the indication of the selection of the subset of processing cores for the testing process; or store the indication of the selection of the subset of processing cores for the testing process.

Aspect 18 is the apparatus of any of aspects 1-17, where the at least one memory is configured to store an on-chip test pattern associated with the testing process, and where the on-chip test pattern is agnostic to a fusing capability associated with the apparatus.

Aspect 19 is a method for implementing any of aspects 1 to 18.

Aspect 20 is a computer-readable medium (e.g., a non-transitory computer-readable medium) storing computer executable code, the code when executed by at least one processor causes the at least one processor to implement any of aspects 1 to 18.

Aspect 21 is an apparatus comprising means for implementing any of aspects 1 to 18.

What is claimed is:

1. An apparatus for communication at a device, comprising:
at least one memory; and
at least one processor coupled to the at least one memory and, based at least in part on information stored in the at least one memory, the at least one processor is configured to:
identify whether each of a set of processing cores is functional or non-functional, wherein the set of processing cores is associated with a testing process at the device;
select a subset of processing cores in the set of processing cores for the testing process based on whether each of the set of processing cores is functional or non-functional, wherein each of the subset of processing cores is functional; and
output an indication of the selection of the subset of processing cores for the testing process.

2. The apparatus of claim 1, wherein the at least one processor is further configured to:
obtain an indication of the testing process at the device, wherein the testing process is associated with the set of processing cores.

3. The apparatus of claim 2, wherein the at least one processor is further configured to:
initiate the testing process at the device based on the indication of the testing process.

4. The apparatus of claim 2, wherein the testing process includes data for the testing process or a set of vectors for the testing process, and wherein the at least one processor is further configured to:
store, at the device, the data for the testing process or the set of vectors for the testing process.

5. The apparatus of claim 1, wherein the testing process is a self-testing process at the device, a built-in self-test (BIST) process at the device, or a hardware-enabled BIST at the device.

6. The apparatus of claim 1, wherein to identify whether each of the set of processing cores is functional or non-functional, the at least one processor is configured to:
obtain an indication of whether each of the set of processing cores is functional or non-functional.

7. The apparatus of claim 1, wherein to identify whether each of the set of processing cores is functional or non-functional, the at least one processor is configured to:
perform a test on each of the set of processing cores to identify whether each of the set of processing cores is functional or non-functional.

8. The apparatus of claim 7, wherein to perform the test on each of the set of processing cores, the at least one processor is configured to:
perform a multiple phase test on each of the set of processing cores to identify whether each of the set of processing cores is functional or non-functional, wherein a first phase of the multiple phase test includes a test for at least one first processing core in the set of processing cores and a second phase of the multiple phase test includes a test for at least one second processing core in the set of processing cores.

9. The apparatus of claim 1, wherein to select the subset of processing cores for the testing process, the at least one processor is configured to:
select, at a system-on-chip (SoC) of the device, the subset of processing cores in the set of processing cores for the testing process.

10. The apparatus of claim 1, wherein to select the subset of processing cores for the testing process, the at least one processor is configured to:
select a first subset of functional processing cores, wherein the set of processing cores includes a second set of non-functional processing cores that are unselected.

11. The apparatus of claim 10, wherein the at least one processor is further configured to:
refrain from utilizing the second set of non-functional processing cores based on the selection of the first subset of functional processing cores.

12. The apparatus of claim 11, wherein to refrain from utilizing the second set of non-functional processing cores, the at least one processor is configured to:
disable all of the second set of non-functional processing cores based on the selection of the first subset of functional processing cores.

13. The apparatus of claim 1, wherein the at least one processor is further configured to:
generate a set of signals for the subset of processing cores based on the selection of the subset of processing cores; and
map, based on the generation of the set of signals, each of the set of signals to each of the subset of processing cores.

14. The apparatus of claim 13, wherein the set of signals for the subset of processing cores is a set of phase-wise control signals for the subset of processing cores.

15. The apparatus of claim 1, wherein the at least one processor is further configured to:
generate a mask for the subset of processing cores based on the selection of the subset of processing cores, wherein the mask for the subset of processing cores includes a set of mask signals for the subset of processing cores.

16. The apparatus of claim 15, wherein to generate the mask for the subset of processing cores, the at least one processor is configured to:
generate the mask for the subset of processing cores for a first logic testing process and a second memory testing process; and
store the mask for the subset of processing cores for the first logic testing process and the second memory testing process, and wherein the at least one processor is further configured to:
determine whether to overwrite the mask for the first logic testing process and the second memory testing process based on a debugging process; and
overwrite the mask for the first logic testing process and the second memory testing process based on the debugging process.

17. The apparatus of claim 1, wherein to output the indication of the selection of the subset of processing cores for the testing process, the at least one processor is configured to:
initiate the testing process at the device including the subset of processing cores;
transmit the indication of the selection of the subset of processing cores for the testing process; or
store the indication of the selection of the subset of processing cores for the testing process.

18. The apparatus of claim 1, wherein the at least one memory is configured to store an on-chip test pattern associated with the testing process, and wherein the on-chip test pattern is agnostic to a fusing capability associated with the apparatus.

19. A method for communication performed by a device, comprising:
identifying whether each of a set of processing cores is functional or non-functional, wherein the set of processing cores is associated with a testing process at the device;
selecting a subset of processing cores in the set of processing cores for the testing process based on whether each of the set of processing cores is functional or non-functional, wherein each of the subset of processing cores is functional; and
outputting an indication of the selection of the subset of processing cores for the testing process.

20. A computer-readable medium storing computer executable code, the code when executed by at least one processor causes the at least one processor to:
identify whether each of a set of processing cores is functional or non-functional, wherein the set of processing cores is associated with a testing process at a device;
select a subset of processing cores in the set of processing cores for the testing process based on whether each of the set of processing cores is functional or non-functional, wherein each of the subset of processing cores is functional; and
output an indication of the selection of the subset of processing cores for the testing process.
